(19) United States
(12) Patent Application Publication
(10) Pub. No.: US 2013/0120242 A1
(43) Pub. Date: May 16, 2013

(54) OPTICAL POINTING DEVICE AND ELECTRONIC DEVICE INCLUDING SAME

(71) Applicant: Hideya TAKAKURA, Osaka-shi (JP)

(72) Inventor: Hideya TAKAKURA, Osaka-shi (JP)

(73) Assignee: SHARP KABUSHIKI KAISHA

(21) Appl. No.: 13/677,372

(22) Filed: Nov. 15, 2012

(30) Foreign Application Priority Data
Nov. 16, 2011 (JP) 2011-251059
Aug. 7, 2012 (JP) 2012-175446

(51) Int. Cl. G06F 3/03

(52) U.S. Cl. CPC G06F 3/0304
USPC 345/156

(57) ABSTRACT

An optical pointing device is configured so that: an optical unit and a lens unit are integrally molded and form a portion of an optical cover; each of a light transmitting resin layer and the optical cover is made of a resin containing thermosetting resin as a main component; and a light shielding resin layer is made of a resin containing, as a main component, thermosetting resin and/or thermoplastic resin that has heat resistance. Thereby, the present invention provides an optical pointing device whose optical characteristics, reliability and heat resistance are excellent and whose number of component members are reduced.

This Nonprovisional application claims priority under 35 U.S.C. §119 on Patent Applications No. 2011-251059 filed in Japan on Nov. 16, 2011, and No. 2012-175446 filed in Japan on Aug. 7, 2012, the entire contents of which are hereby incorporated by reference.

### TECHNICAL FIELD

The present invention relates to an optical pointing device detecting movement of an object such as a fingertip, and an electronics device including the optical pointing device. More specifically, the present invention relates to an optical pointing device (i) that has an excellent heat resistance that allows application of reflow soldering, (ii) that has excellent optical characteristics and reliability, and (iii) that consists of a reduced number of component members, and an electronics device including the device.

### BACKGROUND ART

For an input interface of a portable information terminal such as a mobile phone, PDA (Personal Digital Assistants), and the like, a keypad is generally employed. The keypad is constituted by buttons for inputting numeral numbers, letters, and the like, and buttons for indicating directions.

Meanwhile, in recent years, it has become possible to present graphics and the like on a display section of such a portable information terminal. This has made it possible to use the display section in two dimensions.

As described above, functions of the portable information terminal have become similar to those of computers. As a result, though desired functional operations are executed by using menu keys and other functional keys as directional keys in a conventional method, this conventional method has become inconvenient as an input method for such a portable information terminal. Consequently, there have arisen demands for a pointing device that allows operations performed by using, for example, a mouse or touch pad which is used for computers.

There is an optical pointing device proposed as such a pointing device. In this optical pointing device, a change on a contact plane of the optical pointing device is obtained by monitoring, with the use of an image pick-up element, an image of a finger or the like that comes in contact with the contact plane.

In the above configuration, the contact plane is illuminated by a light source and an image of the fingertip or the like on the contact plane is formed on the image pick-up element by using a lens. Then, by detection of a change in the image, movement of the fingertip or the like is converted to input signals.

For example, Patent Literature 1 discloses an optical pointing device as an optical pointing device (i) that prevents disturbance light and stray light from entering a light receiving element, and (ii) that has a reduced number of component members. Thus disclosed optical pointing device includes an optical component member in which an optical unit and a lens unit are integrated into one unit.

Further, Patent Literature 2 discloses an optical pointing device as an optical pointing device that makes it possible to reduce the number of component members and the number of steps in production. This optical pointing device has a structure including: a bending element for reflecting incident light; an image forming element for forming an image by further reflecting thus reflected light into an opposed direction in a horizontal direction; and an emission section emitting light of the image formed by the image forming element.

Further, Patent Literature 3 proposes a thin compact optical pointing device. In this optical pointing device, light emitted from an LED light source is transmitted through an inclined plane of a bending element while refracted by the inclined plane, and illuminates a contact plane. This illumination light is diffusedly reflected by an object on the contact plane. A portion of thus diffusedly reflected light passes through the bending element, and an optical path of this light portion is shifted at the inclined plane, so that an image is formed by a lens.

As described above, various optical pointing devices have been conventionally developed. Meanwhile, in recent years, reduction in size of component members and mounting of component members at a higher density have progressed. As a result, studies for improving heat resistance is being made for allowing surface mounting of various component members by means of reflow soldering or the like.

Patent Literature 4 proposes a high-performance optical ranging sensor that is compact and inexpensive. This optical ranging sensor can be mounted by means of reflow soldering or flow soldering.

This optical ranging sensor is configured by (i) preparing a molded resin article obtained by sealing a light emitting element with light-transmitting resin and a molded resin article obtained by sealing a light receiving element and a signal processing section with light-transmitting resin, (ii) forming a molded resin article by integral molding of the above molded resin articles, with light-shielding resin, and (iii) covering an upper surface and both side surfaces of thus integrally molded resin article, with a metallic lens plate that is provided with thermosetting resin lenses.

In addition, Patent Literature 5 discloses an electronic module that can be produced by a method including a reflow soldering process and that employs thermosetting resin.

The electronic module is produced by (i) assembling an image pick-up lens onto a circuit substrate on which at least an electronic component and a solder material are mounted and (ii) heating the circuit substrate including the image pick-up lens to a temperature at which the solder material melts. The image pick-up lens employed here is an optical element obtained by molding thermosetting resin.

### CITATION LIST

Patent Literatures

Patent Literature 1
Japanese Patent Application Publication, Tokukai, No. 2011-48468 (Publication Date: Mar. 10, 2011)

Patent Literature 2
Japanese Patent Application Publication, Tokukai, No. 2011-76392 (Publication Date: Apr. 14, 2011)

Patent Literature 3
Japanese Patent Application Publication, Tokukai, No. 2010-165138 (Publication Date: Jul. 29, 2010)

Patent Literature 4
Japanese Patent Application Publication, Tokukai, No. 2011-43433 (Publication Date: Mar. 3, 2011)

Patent Literature 5
Japanese Patent Application Publication, Tokukai, No. 2009-122436 (Publication Date: Jun. 4, 2009)

### SUMMARY OF INVENTION

### Technical Problem

In recent years, it has been demanded that an optical pointing device becomes a module that has an excellent heat resistance that allows mounting by means of reflow soldering (hereinafter, also simply referred to as “reflow soldering”). Further, the optical pointing device is required to have not only an excellent heat resistance but also to excellent optical characteristics and reliability (operational stability).

However, Patent Literatures 1 to 3 above proposes no optical pointing device whose structure satisfies heat resistance that is required in surface mounting.

Further, a technique disclosed in Patent Literature 4 or 5 is merely a proposal of a lens that has heat resistance. However, Patent Literatures 4 and 5 disclose no configuration for (i) improving optical characteristics and reliability of an optical pointing device and (ii) satisfying heat resistance required in reflow soldering of the optical pointing device.

In other words, Patent Literatures 4 and 5 proposes nothing about, for example, a configuration in which a lens and a cover covering an entire module are integrated or a configuration in which a position of each component member is fixed.

The present invention is attained in the above problems. An object of the present invention is to provide an optical pointing device (i) that has an excellent heat resistance that allows application of reflow soldering, (ii) that has excellent optical characteristics and reliability, and (iii) that consists of a reduced number of component members.

### Solution to Problem

In order to solve the above problem, an optical pointing device of the present invention includes: a light emitting element provided on a substrate and emitting light onto an object; an image pick-up element provided on the substrate and receiving light reflected by the object; a light transmitting resin layer sealing the light emitting element and the image pick-up element; a light shielding resin layer sealing the light transmitting resin layer, except a section having a possibility of becoming a path of the incident light and a path of the light reflected by the object; and a cover section sealing the light shielding resin layer, the cover section being integrally molded with an optical unit and a lens unit, the optical unit refracting incident light from the light emitting element toward the object, the lens unit collecting the light reflected by the object, the light transmitting resin layer and the cover section each being made of a resin containing thermosetting resin as a main component, the light shielding resin layer being made of a resin containing, as a main component, thermosetting resin and/or thermoplastic resin that has heat resistance.

In the above configuration, the optical unit and the lens unit are integrally molded, and thereby, form a portion of the cover section. This cover section seals the light shielding resin layer and becomes an outer package of an entire optical pointing device.

Therefore, light having transmitted the optical unit and the light reflected by the object are neither reflected nor attenuated at a boundary surface between the optical unit and the cover section and between the lens unit and the cover section.

This makes it possible to cause the light having transmitted the optical unit to directly reach the object and further to cause the light reflected by the object to directly reach the lens unit.

Further, there is no gap between the optical unit and the cover section and between the lens unit and the cover section. Accordingly, the optical unit and the lens unit are never slanted by vibration. Further, no moisture or foreign substance comes in such a gap.

Therefore, an optical path can be kept as a desired optical path and proper signal light can be transmitted.

Furthermore, the light emitting element and the image pick-up element are sealed with the light transmitting resin layer. The light transmitting resin layer is sealed with the light shielding resin layer, except a section that forms the optical path. This makes it possible to prevent disturbance light and stray light from entering the image pick-up element.

As described above, the present invention can provide an optical pointing device that is much superior in optical characteristics and reliability to a conventional optical pointing device. Further, in the present invention, it is not necessary to prepare a separate cover section. Therefore, the number of component members can be reduced. In addition, a size of the optical pointing device can be reduced.

In the optical pointing device of the present invention, each of the light transmitting resin layer and the cover section is made of a resin containing thermosetting resin as a main component. Further, the light emitting element and the image pick-up element are sealed with this light transmitting resin layer. In addition, the light shielding resin layer is made of a resin containing thermosetting resin and/or thermoplastic resin having heat resistance as a main component.

Therefore, each of substantially all the component members constituting the optical pointing device has an excellent heat resistance that is given by the thermosetting resin and/or the thermoplastic resin that has heat resistance. Therefore, it becomes possible to provide an optical pointing device that has a sufficiently high resistance to heat and that can be subjected to a process, such as reflow soldering, in which a high heat resistance is required.

### Advantageous Effects of Invention

As described above, an optical pointing device of the present invention is configured to include: a light emitting element provided on a substrate and emitting light onto an object; an image pick-up element provided on the substrate and receiving light reflected by the object; a light transmitting resin layer sealing the light emitting element and the image pick-up element; a light shielding resin layer sealing the light transmitting resin layer, except a section having a possibility of becoming a path of the incident light and a path of the light reflected by the object; and a cover section sealing the light shielding resin layer, the cover section being integrally molded with an optical unit and a lens unit, the optical unit refracting incident light from the light emitting element toward the object, the lens unit collecting the light reflected by the object, the light transmitting resin layer and the cover section each being made of a resin containing thermosetting resin as a main component, the light shielding resin layer being made of a resin containing, as a main component, thermosetting resin and/or thermoplastic resin that has heat resistance.

Therefore, it is possible to provide an optical pointing device (i) that has excellent optical characteristics and reliability, (ii) that has a sufficient heat resistance that allows application of reflow soldering, and (iii) that consists of a reduced number of component members.

### BRIEF DESCRIPTION OF DRAWINGS

FIG. 1 is a cross sectional structural drawing schematically illustrating an optical pointing device of Embodiment 1.

FIG. 2 is a cross sectional structural drawing schematically illustrating an optical pointing device in which a light transmitting resin layer does not have a depression between a light emitting element and an image pick-up element.

FIG. 3 is a cross sectional structural drawing schematically illustrating an optical unit, a lens unit, and an optical cover of an optical pointing device (i) whose optical unit and lens unit are integrally molded but (ii) whose optical cover is not integrally molded with the optical unit and the lens unit.

FIG. 4 is a cross sectional structural drawing schematically illustrating an optical pointing device according to Embodiment 2.

FIG. 5 is a schematic diagram illustrating a state in which an optical pointing device is assembled by (i) engaging a light transmitting resin layer with a light shielding resin layer and (ii) engaging a cover section with the light shielding resin layer.

FIG. 6 is a schematic diagram illustrating a state where an optical pointing device is being assembled by using projections formed on a light transmitting resin layer and a light shielding resin layer, each of which projections is originating from a gate.

FIG. 7 is a schematic view illustrating Embodiment 6 of the present invention; (a) of FIG. 7 illustrates an appearance of a cover section where an image pick-up surface is formed in a depression; and (b) of FIG. 7 is a schematic view illustrating from a side surface of an optical pointing device employing the cover section as shown in (a) of FIG. 7 in a case where the optical pointing device is viewed from a side surface thereof.

### DESCRIPTION OF EMBODIMENTS

The following discusses in detail embodiments of the present invention, with reference to drawings. Note that members having identical functions and effects are given identical reference signs, and their explanations are omitted.

### Embodiment 1

### (1) Optical Pointing Device According To Embodiment 1

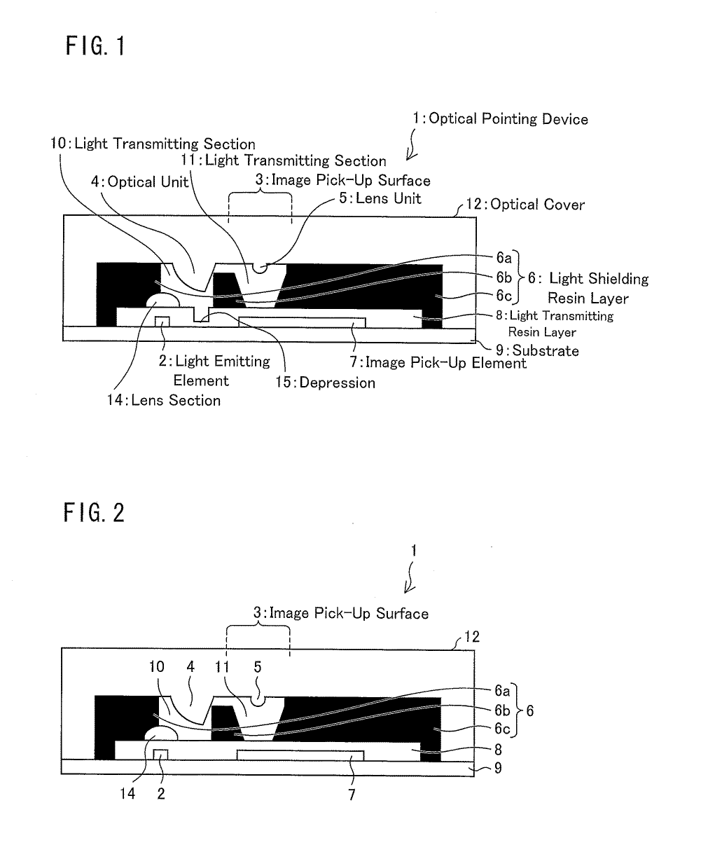

The following discusses Embodiment 1 of the present invention with reference to FIG. 1. FIG. 1 is a cross sectional structural drawing schematically illustrating an optical pointing device 1 according to Embodiment 1.

As shown in FIG. 1, the optical pointing device 1 includes a light emitting element 2, an image pick-up surface 3, an optical unit 4, a lens unit 5, a light shielding resin layer (light shielding resin) 6, an image pick-up element 7, a light transmitting resin layer (light transmitting resin) 8, a substrate 9, and an optical cover (cover section) 12.

Further, the light transmitting resin layer 8 has a lens section 14. The optical unit 4 and the lens unit 5 are integrally molded and form a portion of the optical cover 12.

In FIG. 1, the reference sign 10 indicates a space that may be an incident light path from the light emitting element 2 to the optical unit 4. Meanwhile, the reference sign 11 indicates a space that may be a reflected light path from the lens unit 5 to the image pick-up element 7. In the present specification, each of these spaces respectively indicated by the reference signs 10 and 11 is also referred to as a “light transmitting section”.

In Embodiment 1, the light emitting element 2 and the image pick-up element 7 are mounted on the single substrate 9, and electrically connected to this substrate 9 by wire bonding or flip chip mounting.

On the substrate 9, though not shown, a circuit is formed. This circuit controls timing of light emission carried out by the light emitting element 2. The circuit also detects a movement of an object by receiving an electric signal that has been outputted from the image pick-up element 7.

The substrate 9 is made of a single material and has a planar shape. The substrate 9 is made of, for example, a printed board, a lead frame, or the like.

The image pick-up surface 3 is a section where the object comes in contact. As shown in FIG. 1, the image pick-up surface 3 is positioned above the image pick-up element 7. This image pick-up surface 3 is a part of an outer surface of the optical cover 12.

The light emitting element 2 illuminates the object such as a fingertip or the like that comes in contact with the image pick-up surface 3. The light emitted from the light emitting element 2 is refracted by the optical unit 4 via the lens section 14 that is provided to the light transmitting resin layer 8, and thereby, a direction in which the light travels is shifted. Consequently, the light reaches the image pick-up surface 3.

The light emitting element 2 is realized by a light source such as an LED or the like. In particular, the light emitting element 2 is preferably realized by an infrared light emitting diode having a high luminance.

The image pick-up element 7 receives light that is emitted from the light emitting element 2 and reflected by the object. In accordance with the light received, the image pick-up element 7 forms an image of the object on the image pick-up surface 3, and converts the image to image data. The image pick-up element 7 is not specifically limited but may be an image sensor such as a CMOS, a CCD, or the like.

Though not shown, the image pick-up element 7 includes a digital signal processor (calculation section, hereinafter, referred to as a “DSP”), and takes in thus received light into the DSP in the form of image data. The image pick-up element 7 keeps capturing an image on the image pick-up surface 3 at a predetermined interval, according to instructions from the substrate 9.

When the object in contact with the image pick-up surface 3 moves, a current image currently captured by the image pick-up element 7 is different from an immediately preceding image captured immediately before the current image. The image pick-up element 7 compares, in the DSP, (i) a value of image data at a position in the current image and (ii) a value of image data of the immediately preceding image at a position that is identical to the position in the current image. Then, the image pick-up element 7 calculates a shift amount or a shift direction of the object.

In other words, when the object on the image pick-up surface 3 moves, the image data of the current image shows a value that is shifted by a predetermined amount from that of the image data of the immediately preceding image.

Then, the image pick-up element 7 calculates a shift amount and a shift direction of the object from the predetermined amount, in the DSP. The image pick-up element 7 then outputs, as an electric signal, thus calculated shift amount and shift direction to the substrate 9.

In other words, when no object is present on the image pick-up surface 3, the image pick-up element 7 captures an image of the image pick-up surface 3. Then, when an object comes in contact with the image pick-up surface 3, the image pick-up element 7 captures an image of a surface of the object that is in contact with the image pick-up surface 3. For example, in a case where the object is a fingertip, the image pick-up element 7 captures an image of a fingerprint of the fingertip.

In the above case where the object comes in contact with the image pick-up surface 3, image data captured by the image pick-up element 7 is different from image data captured in a case where no object is present on the image pick-up surface 3. Therefore, in such a case, the DSP of the image pick-up element 7 transmits, to the substrate 9, a signal indicating that an object is in contact with the image pick-up surface 3.

Then, when the object moves, the DSP of the image pick-up element 7 compares current image data with immediately preceding image data captured immediately before the current image data, so as to calculate a shift amount and a shift direction of the object. Subsequently, the DSP transmits, to the substrate 9, a signal indicative of thus calculated shift amount and shift direction of the object.

Note that the DSP is not necessarily provided inside the image pick-up element 7, but may be provided in the substrate 9. In such a case, the image pick-up element 7 transmits, to the substrate 9, image data of captured images in the order of image capturing.

### (2) Sealing Of Light Emitting Element And Image Pick-Up Element With Light Transmitting Resin Layer

The light emitting element 2 and the image pick-up element 7 are sealed with a light transmitting resin layer 8. On a bottom surface of the light transmitting resin layer 8, depressions are formed. The light emitting element 2 and the image pick-up element 7 fit in these depressions, respectively. The bottom surface of the light transmitting resin layer 8 is put in close contact with an upper surface of the substrate 9, except at positions where the depressions are provided.

In the present embodiment, a shape of the light transmitting resin layer 8 is substantially rectangular parallelepiped. On an upper surface (top surface) of the light transmitting resin layer 8, the lens section 14 that is semispherical (in a plano-concave shape) is formed. The lens section 14 is provided above the light emitting element 2, and collects light emitted from the light emitting element 2.

Because the lens section 14 is formed, a light path of light emitted from the light emitting element 2 can be easily shifted into a direction of the optical unit 4. This makes it possible to efficiently illuminate the object. It is optional whether or not the light transmitting resin layer 8 includes the lens section 14. However, as described above, the light transmitting resin layer 8 preferably includes the lens section 14.

In the present invention, the light transmitting resin layer 8 is made of light transmitting resin containing thermosetting resin as a main component. The phrase “the light transmitting resin layer 8 is made of light transmitting resin containing thermosetting resin as a main component” means that the light transmitting resin layer 8 is made of a cured material containing thermosetting resin as a base resin. The above phrase also means that the light transmitting resin contains therein thermosetting resin in a range of more than 50% by weight and not more than 100% by weight in a case where a weight of the light transmitting resin is 100% by weight. This makes it possible to remarkably improve a heat resistance of the light transmitting resin layer 8.

The thermosetting resin is not specifically limited. Examples of the thermosetting resin are phenol resin, epoxy resin, silicone resin, urea resin, melamine resin, unsaturated polyester resin, and the like. The light transmitting resin may contain one kind or two or more kinds of thermosetting resin. In a case where the light transmitting resin contains two or more kinds of thermosetting resin, a ratio of the two or more kinds of thermosetting resin employed may be determined as appropriate. For example, the light transmitting resin layer 8 may be made of commercially available resin or alternatively may be obtained by curing thermosetting resin by a conventionally known method.

Other than the thermosetting resin, the light transmitting resin may contain, as a component, a curing agent. The curing agent is not specifically limited. The curing agent may be, for example, a conventionally known curing agent such as an amine curing agent, an acid anhydride curing agent, a latent curing agent, or the like.

Other than the thermosetting resin and the curing agent, the light transmitting resin may contain, as a component, a minute amount of a filler such as silica filler, a flame retardant, a release agent, an additive for shielding light of a specific wavelength, or the like.

In the present invention, the cover section also contains thermosetting resin as a main component. This is described later. Further, the light shielding resin layer 6 is made of light shielding resin containing, as a main component, thermosetting resin and/or thermoplastic resin that has heat resistance. Therefore, the optical pointing device of the present invention has a very high heat resistance.

Accordingly, in regard to the optical pointing device of the present invention, even in a case where the optical pointing device is exposed to a high-temperature processing condition (i.e., a temperature in a range of not less than 220° C. and not more than 260° C.) in reflow soldering, no damage is produced on an appearance and no deterioration occurs in optical characteristics. This optical pointing device has a sufficient resistance to reflow soldering in which lead-free solder is employed.

A method of sealing the light emitting element 2 and the image pick-up element 7 with the light transmitting resin layer 8 is not specifically limited. The method may be a conventionally known method.

For example, it is possible to employ a conventionally known molding method by which the light transmitting resin layer 8 is molded so that the light emitting element 2 and the image pick-up element 7 provided on the substrate 9 respectively fit in depressions provided in the light transmitting resin layer 8.

Examples of the conventionally known molding method that can be employed in the present invention are transfer molding, injection molding, compression molding, and the like. The conventionally known molding method is not specifically limited. However, the conventionally known molding method is preferably transfer method because in transfer molding, an excellent dimensional precision can be obtained and less warping or distortion occurs.

The light transmitting resin layer 8 is sealed with the light shielding resin layer 6 described later, except a section that may become a path of incident light from the light emitting element 2 to the optical unit and a section that may become a path of light reflected by an object.

FIG. 2 is a cross sectional structural drawing schematically illustrating an optical pointing device in which the light transmitting resin layer 8 has no depression between the light emitting element 2 and the image pick-up element 7.

The optical pointing device 1 can prevent, by means of the light shielding resin layer 6, disturbance light from entering the image pick-up element 7. Accordingly, as shown in FIG. 2, the light transmitting resin layer 8 may be arranged to have a substantially rectangular parallelepiped shape and have no depression between the light emitting element 2 and the image pick-up element 7.

However, note that, as shown in FIG. 1, the optical pointing device 1 is preferably arranged so that: the light transmitting resin layer 8 has a depression 15 positioned between the light emitting element 2 and the image pick-up element 7; and a distance from the substrate 9 to a bottom surface of the depression 15 is not more than a height of the light emitting element 2. This arrangement is preferable because light can be prevented from directly entering the image pick-up element 7 from the light emitting element 2. A width of an aperture section of the depression 15 is not specifically limited. The larger width of the aperture section provides a better light shielding characteristic.

The above arrangement makes it possible to prevent stray light from causing malfunction of the optical pointing device 1. This makes it possible to improve accuracy in detection of an object. Note that the depression 15 can be fabricated by providing a shape of the depression 15 in a metal mold employed in the conventionally known molding. Though not shown, the distance from the substrate 9 to the bottom surface of the depression 15 may be zero. In other words, it is possible to have an arrangement such that: the bottom surface of the depression 15 is at the same level as a top surface of the substrate 9; and the light transmitting resin layer 8 is not present between the substrate 9 and the bottom surface of the depression 15.

In such a case, the light emitting element 2 and the image pick-up element 7 are sealed with separate light transmitting resin layers (light transmitting resins). Accordingly, the light transmitting resin layers are completely apart from each other. Therefore, stray light can be more reliably prevented from entering the image pick-up element 7.

In the above case, respective materials of the separate light transmitting resin layers may be the same, or different as long as each of the materials contains, as a main component, thermosetting resin.

### (3) Sealing Light Transmitting Resin Layer With Light Shielding Resin Layer

The light shielding resin layer 6 is formed so as to surround the light transmitting resin layer 8. Thereby, the light transmitting resin layer 8 is sealed with the light shielding resin layer 6 as described above, except a section that may become a path of incident light from the light emitting element 2 to the optical unit 4 and a section that may become a path of reflected light from the lens unit 5 to the image pick-up element 7. This makes it possible to provide an optical pointing device that suffers less influence of disturbance light.

The phrase “a section that may become a path of incident light” indicates a section through which light emitted from the light emitting element 2 passes in the light transmitting resin layer 8 before reaching the optical unit 4. For example, in FIG. 1, the “section that may become a path of incident light” indicates a section in the light transmitting resin layer 8 which section faces the light transmitting section 10.

The phrase “a section that may become a path of reflected light” indicates a section through which light reflected by an object passes in the light transmitting resin layer 8 after passing through the lens unit 5 and before reaching the image pick-up element 7. For example, in FIG. 1, in the light transmitting resin layer 8, the “section that may become a path of reflected light” is a section in the light transmitting resin layer 8 which section faces the light transmitting section 11. The light transmitting sections 10 and 11 are not sealed with resin but are empty spaces. The light shielding resin layer 6 in FIG. 1 is made of light shielding resin layers (light shielding resins) 6a, 6b, and 6c.

The light shielding resin layer 6b is formed between the light emitting element 2 and the image pick-up element 7 so as to separate the light transmitting sections 10 and 11.

This light shielding resin layer 6b effectively prevents stray light from entering the image pick-up element 7. However, note that the light shielding resin layer 6b is not necessarily formed. In a case where influence of stray light is not taken into consideration, it is not necessary to form the light shielding resin layer 6b.

The light shielding resin layers 6a and 6c respectively have inner surfaces that are put in close contact with the top surface and side surfaces of the light transmitting resin layer 8. Further, the light shielding resin layers 6a and 6c respectively have bottom surfaces that are put in close contact with the top surface of the substrate 9. In addition, the light shielding resin layer 6b has a bottom surface that is put in close contact with the top surface of the light transmitting resin layer 8.

The light shielding resin layer 6 is made of light shielding resin. There are a case where the light shielding resin contains thermosetting resin as a main component, like the light transmitting resin, and a case where the light shielding resin contains, as a main component, thermoplastic resin that has heat resistance. In other words, in a case where thermosetting resin is employed, the light shielding resin layer 6 is made of a cured material containing therein, as a base resin, thermosetting resin. In this case, the light shielding resin is required to contain thermosetting resin in a range of more than 50% by weight and less than 100% by weight in a case where a weight of the light shielding resin is 100% by weight.

Meanwhile, in a case where the light shielding resin contains, as a main component, thermoplastic resin that has heat resistance, the light shielding resin layer 6 is made of a cured material containing, as a base resin, thermoplastic resin that has heat resistance. In this case, the light shielding resin is required to contain thermoplastic resin that has heat resistance, in a range of more than 50% by weight and less than 100% by weight in a case where a weight of the light shielding resin is 100% by weight.

In the present specification, the phrase “thermoplastic resin that has heat resistance” means any thermoplastic resin that has heat resistance to a temperature in a range of at least not less than 220° C. More preferably, the “thermoplastic resin that has heat resistance” is thermoplastic resin that has heat resistance to a temperature in a range of at least not less than 220° C. and not more than 260° C.

In the present specification, the phrase “thermoplastic resin that has heat resistance to a temperature in a range of at least not less than 220° C.” means thermoplastic resin that shows no significant change in appearance and optical characteristics after execution and completion of reflow soldering that may cause a surface temperature of the thermoplastic resin to be 220° C. or higher.

Further, in the present specification, the phrase “thermoplastic resin that has heat resistance to a temperature in a range of not less than 220° C. and not more than 260° C.” means thermoplastic resin that shows no significant change in appearance and optical characteristics after execution and completion of reflow soldering that may cause a surface temperature of the thermoplastic resin to be 220° C. or higher and 260° C. or less.

The thermosetting resin may be resin described above as the examples that may be employed as the light transmitting resin. The thermoplastic resin that has heat resistance is not specifically limited, and may be, for example, VECTRA® LCP, AMODEL®polyphthalamide, or the like. However, note that the light shielding resin is required to have a light shielding property, and therefore, the light shielding resin contains black pigment.

The black pigment is not specifically limited, and may be organic black pigment such as carbon black, aniline black, perylene black or the like, inorganic black containing copper, iron, chrome, manganese, cobalt, or the like, titanium black, or the like.

The light shielding resin may contain one kind or two or more kinds of thermosetting resin and/or thermoplastic resin that has heat resistance. In a case where two or more kinds of thermosetting resin and/or thermoplastic resin is used, two or more kinds of only thermosetting resin may be used or alternatively, two or more kinds of only thermoplastic resin that has heat resistance may be used. As a further alternative, it is also possible to use one or more kind of thermosetting resin and one or more kind of thermoplastic resin that has heat resistance in combination. In the case where two or more kinds of thermosetting resin and/or thermoplastic resin are used, a ratio at which each resin is used may be determined as appropriate.

Further, the light shielding resin layer 6 may be made of, for example, commercially available resin. Alternatively, the light shielding resin layer 6 may be made of a cured material obtained by curing a mixture of thermosetting resin and black pigment by a conventionally known method. As a further alternative, the light shielding resin layer may be made of a mixture of black pigment and thermoplastic resin that has heat resistance.

The above-described curing agent may be contained as a component in the light shielding resin, in addition to (i) the black pigment and (ii) the thermosetting resin or the thermoplastic resin that has heat resistance. Further, the light shielding resin may also contain a minute amount of the above-described filler or the like.

Note that a content of the black pigment in the light shielding resin is not specifically limited, as long as a light shielding property can be given by the content of the black pigment.

As a method for sealing the light transmitting resin layer 8 with the light shielding resin layer 6 except the section that may be the path of incident light from the light emitting element 2 to the optical unit 4 and the section that may be the path of reflected light from the lens unit 5 to the image pick-up element 7, the above-described conventionally known molding method can be employed.

For example, the light transmitting resin layer 8 can be sealed with the light shielding resin layer 6 as described above, by (i) subjecting, to transfer molding, the light emitting element 2 and the image pick-up element 7 that are formed on the substrate 9 and sealed with the light transmitting resin layer 8 and (ii) supplying light shielding resin into a metal mold.

According to need, the light shielding resin layer 6b can be formed by, for example, further performing additional transfer molding after molding of the light shielding resin layers 6a and 6c by transfer molding.

### (4) Cover Section

The optical unit 4 and the lens unit 5 are integrally molded, and form a portion of the optical cover 12 that seals therein the light shielding resin layer 6. In other words, respective portions of the optical cover 12 are the optical unit 4 and the lens unit 5.

The optical unit 4 is provided for refracting light emitted from the light emitting element 2 so that the light is thrown onto an object. The lens unit 5 collects light that is emitted from the light emitting element 2 and that is reflected by the object, and forms an image onto the image pick-up element 7 from thus collected light.

As a method for integrally molding the optical unit 4, the lens unit 5, and the optical cover 12, a conventional known molding method such as transfer molding can be employed.

Because the optical unit 4, the lens unit 5, and the optical cover 12 are integrally molded, the optical unit 4, the lens unit 5, and the optical cover 12 are formed from the same material that contains, as a main component, thermosetting resin. The thermosetting resin can be phenol resin or the like as described above.

In other words, the optical unit 4, the lens unit 5, and the optical cover 12 are made of a cured material containing, as a base resin, thermosetting resin. In a case where a total weight of the optical unit 4, the lens unit 5, and the optical cover 12 is 100% by weight, the optical unit 4, the lens unit 5, and the optical cover 12 contain thermosetting resin in a range of more than 50% by weight and not more than 100% by weight.

The optical unit 4, the lens unit 5, and the optical cover 12 may employ one kind or two or more kinds of the thermosetting resin. In a case where two or more kinds of thermosetting resin are used, it is possible to determine as appropriate a ratio of each of the two or more kinds of thermosetting resin employed. In addition to the thermosetting resin, the optical unit 4, the lens unit 5, and the optical cover 12 may contain the above-described curing agent as a component. Further, in addition to the thermosetting resin, the optical unit 4, the lens unit 5, and the optical cover 12 may also contain a minute amount of filler or the like described above.

A method for sealing the light shielding resin layer 6 with the optical cover 12 is not specifically limited.

For example, as shown in FIG. 1, an inner surface of the optical cover 12 (excluding respective sections that face the light transmitting sections 10 and 11) is put in close contact with a top surface of the light shielding resin layer 6 and fixed by an adhesive to this top surface. Meanwhile, a bottom surface of the optical cover 12 is put in close contact with the top surface of the substrate 9 and fixed by an adhesive to this top surface. Thereby, the light shielding resin layer 6 can be sealed.

As a result, the optical cover 12 becomes an outer package cover of the optical pointing device 1. At this time, the light emitting element 2 and the light transmitting section 10 are provided in positions that allow satisfying an optical characteristic such that light emitted from light emitting element 2 is caused to reach the optical unit 4. Further, the image pick-up element 7 and the light transmitting section 11 are provided in positions that allow satisfying an optical characteristic such that light collected by the lens unit 5 is caused to reach the image pick-up element 7.

In FIG. 1, the inner surface of the optical cover 12 (excluding the respective sections that face the light transmitting sections 10 and 11) is put in close contact with the top surfaces of the light shielding resin layers 6a and 6c. However, the present embodiment is not limited this configuration.

It is also possible, for example, (i) to carry out molding so that (a) a height of the light shielding resin layer 6b from the top surface of the light transmitting resin layer 8 becomes equal to (b) a height of the light shielding resin layers 6a and 6c from the top surface of the light transmitting resin layer 8, and (ii) thereby, to cause the inner surface of the optical cover 12 come in close contact with the top surface of the light shielding resin layer 6b.

In a conventionally known optical pointing device, for example, an optical cover is provided as a separate member as in a device disclosed in Patent Literature 1. There has been no proposal of a configuration in which an optical unit and a lens unit that are integrally molded serve as a portion of an optical cover that covers an entire module.

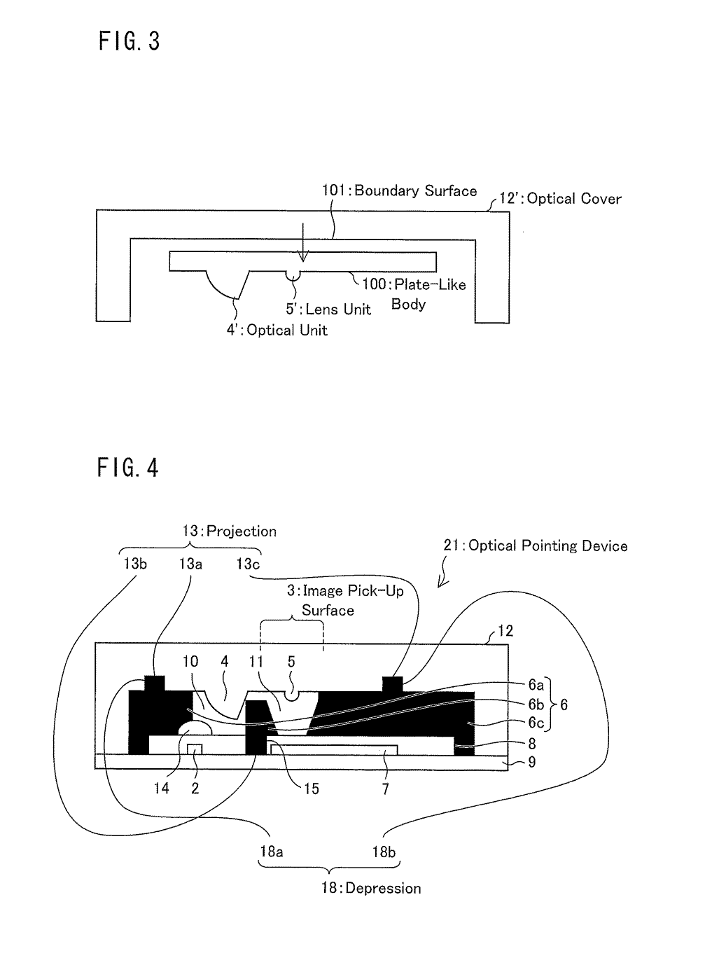

FIG. 3 is a cross sectional structural drawing schematically illustrating an optical unit, a lens unit, and an optical cover in an optical pointing device (i) whose optical unit and lens unit are integrally molded but (ii) whose optical cover is not integrally molded with the optical unit and the lens unit.

In FIG. 3, the reference sign 4′ indicates an optical unit; the reference sign 5′ indicates a lens unit; and the reference sign 12′ indicates an optical cover. In this case, a plate-like body 100 has a surface where the optical unit 4′ and the lens unit 5′ are integrally molded. This plate-like body 100 is not integrally molded with the optical cover 12′, and therefore, has a boundary surface 101 as shown in FIG. 3. In other words, a gap is produced between the plate-like body 100 and the optical cover 12′.

Because this boundary surface 101 is present, light reflected by an object is reflected and attenuates at the boundary surface 101 and then reaches the lens unit 5′.

Further, because the boundary surface 101 is present, the above structure tends to suffer influence of vibration, a foreign substance, moisture, or the like. In other words, it may not be possible to cause the light reflected by the object to appropriately reach the image pick-up element (i) due to slanting of the lens unit 5′ which slanting is caused by vibration or (ii) due to an adverse effect on a light path which adverse effect is caused by a foreign substance, moisture, or the like that comes in between the plate-like body 100 and the optical cover 12′.

On the other hand, in the optical pointing device 1, the optical unit 4, the lens unit 5, and the optical cover 12 are integrally molded, and therefore no boundary surface 101 is present.

Accordingly, it is possible to cause the light reflected by the object to directly reach the lens unit 5 appropriately and further to reach the image pick-up element 7. In addition, the optical pointing device 1 does not suffer the influence of vibration, a foreign substance, moisture, or the like. Therefore, it is possible to provide an optical pointing device that has excellent optical characteristics and reliability.

Here, for giving heat resistance required for subjecting an optical pointing device to reflow soldering, all component members constituting the optical pointing device are required to have such heat resistance. Conventionally, there has been no optical pointing device that is configured so that all component members constituting the optical pointing device are made of respective materials that have such heat resistance.

As described above, in the optical pointing device 1, the optical unit 4, the lens unit 5, and the optical cover 12 are integrally molded as described above, and contain thermosetting resin as a main component. This means that in the optical pointing device 1, each of all the light transmitting resin layer 8, the optical unit 4, the lens unit 5, and the optical cover 12 contains, as a main component, thermosetting resin. Further, the light shielding resin layer contains, as a main component, thermosetting resin and/or thermoplastic resin that has heat resistance.

Further, the optical element 2 and the image pick-up element 7 are sealed with the light transmitting resin layer 8. Therefore, all the component members constituting the optical pointing device can have heat resistance that is required for subjecting the optical pointing device to reflow soldering.

As a result, the optical pointing device of the present invention has an advantage such that: (i) this optical pointing device of the present invention can be mounded by reflow soldering and (ii) even after the optical pointing device is exposed to a high temperature condition (e.g., in a range of not less than 220° C. and not more than 260° C.), no damage is produced on appearance or no deterioration occurs in optical characteristics. Further, it is also possible to provide an optical pointing device that sufficiently allows application of reflow soldering in which lead-free solder is employed.

In addition, in the optical pointing device of the present invention, it is not necessary to additionally provide a separate optical cover because of the integral molding as described above. Therefore, the optical pointing device is advantageous in that (i) the number of component members of the optical pointing device can be reduced and (ii) a size of the optical pointing device can be reduced.

### Embodiment 2

### Depressions And Projections On Component Members In Optical Pointing Device

An optical pointing device of the present invention preferably has an arrangement such that: each of a light transmitting resin layer and a light shielding resin layer has a depression and/or a projection, and (i) at least one of the depression of the light transmitting resin layer is engaged with a corresponding projection of the light shielding resin layer or (ii) at least one of the depression of the light shielding resin layer is engaged with a corresponding projection of the light transmitting resin layer; and/or each of the light shielding resin layer and a cover section has a depression and/or a projection, and (i) at least one of the depression of the light shielding resin layer is engaged with a corresponding projection of the cover section or (ii) at least one of the depression of the cover section is engaged with a corresponding projection of the light shielding resin layer.

In other words, in the optical pointing device of the present invention, preferably, at least two component members are engaged with each other so that a depression or projection of one of the two component members is engaged with a corresponding depression or projection of the other one of the two component members.

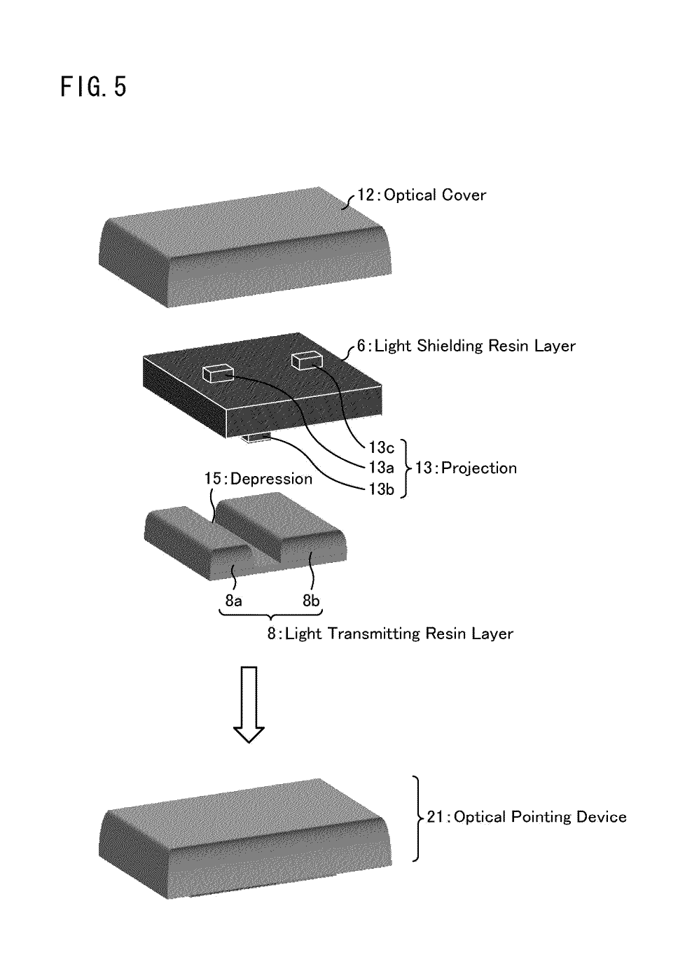

Accordingly, Embodiment 2 discusses an embodiment of engagement between component members constituting the optical pointing device, with reference to FIGS. 4 and 5. FIG. 4 is a cross sectional structural drawing schematically illustrating an optical pointing device 21 of Embodiment 2.

In the optical pointing device 21, a light transmitting resin layer (light transmitting resin) 8 (each of 8a and 8b) has a depression 15. Meanwhile, a light shielding resin layer (light shielding resin) 6 (each of 6a, 6b, and 6c) has projections 13 (13a, 13b, and 13c). An optical cover (cover section) 12 has depressions 18 (18a and 18b).

In the optical pointing device 21, the light transmitting resin layer 8 has the depression 15, and a top surface of a substrate 9 serves as a bottom surface of the depression 15. Accordingly, a light emitting element 2 and an image pick-up element 7 are sealed with separate light transmitting resin layers 8a and 8b, respectively.

The depression 15 of the light transmitting resin layer 8 is engaged with the projection 13b of the light shielding resin layer 6b. Note that in the present specification, respective shapes of the depressions and projections are not specifically limited. Each of the depressions and projections may have any shape, as long as the depressions has a recessed shape and the projections has an protruded shape and there is no gap formed between a depression and a corresponding projection that are engaged with each other. For example, respective shapes of longitudinal sectional view of a depression and a projection may be quadrilateral as shown in FIG. 4, or alternatively, semispherical or triangular.

Further, on the light shielding resin layers 6a and 6c, the projections 13a and 13c are formed. These projections 13a and 13c are engaged with the depressions 18a and 18b of the optical cover 12.

FIG. 5 is a schematic diagram illustrating a state in which the optical pointing device 21 is assembled by (i) engaging the light transmitting resin layer 8 with the light shielding resin layer 6 and (ii) by engaging the optical cover 12 with the light shielding resin layer 6.

For easy understanding of a configuration of the present embodiment, FIG. 5 does not show an image pick-up surface 3 and light transmitting sections 10 and 11. In FIG. 5, by using the projections 13 provided on the light shielding resin layer 6, positioning of the light transmitting resin layer 8, the light shielding resin layer 6, and the optical cover 12 is carried out.

As described above, in the optical pointing device 21, a depression is provided to each of the light transmitting resin layer 8 (8a and 8b) and the optical cover 12. Meanwhile, the projections are provided to the light shielding resin layer 6. Therefore, the optical pointing device can be assembled in a manner such that positioning of component members is precise.

In the optical pointing device 21, an object placed on the image pick-up surface 3 is illuminated by the light emitting element 2. Then, an image is formed on the image pick-up element 7 by a lens unit 5 from light reflected by the object. Subsequently, based on image data, a shift amount and a shift direction of the object are converted to an input signal. Therefore, misalignment of each component member significantly affects optical characteristics of the optical pointing device 21.

In the optical pointing device 21, a depression and a corresponding projection as described above are engaged with each other. Accordingly, the optical pointing device 21 is easily assembled. In addition, strength against an external pressure such as vibration or the like is improved. Therefore, even when vibration or the like is applied on the optical pointing device 21, such misalignment tends not to occur.

Therefore, the optical pointing device 21 can be considered as an optical pointing device (i) that can stably provide desired optical characteristics even when an external pressure is applied, and therefore (ii) that has a high reliability.

Further, in the optical pointing device 21, the projection 13b of the light shielding resin layer 6b is fit in the depression 15. This enhances strength against an external pressure such as vibration or the like. In addition, as compared to a case where the projection 13b is not fit in the depression 15, stray light from the light emitting element 2 is more reliably prevented from entering the image pick-up element 7. Therefore, the optical pointing device 21 is considered to be an optical pointing device that has superior optical characteristics.

In regard to an embodiment of the engagement between the depressions and the projections of component members of the optical pointing device 21, the present embodiment is not limited to those shown in FIGS. 4 and 5. FIG. 4 illustrates an embodiment in which (i) the light transmitting resin layer 8 and the light shielding resin layer 6 are engaged with each other and (ii) the light shielding resin layer 6 and the cover section 12 are engaged with each other. However, the present embodiment may take a configuration in which a light transmitting resin layer and a light shielding resin layer are engaged with each other but the light shielding resin layer and a cover section are not engaged with each other or alternatively, a configuration in which a light transmitting resin layer and a light shielding resin layer are not engaged with each other but the light shielding resin and a cover section are engaged with each other.

Even in the case of such an embodiment, it is possible to provide an optical pointing device that can be assembled more easily and that has an enhanced stability against external pressure, as compared to an optical pointing device of an embodiment shown in FIG. 1 in which none of a light transmitting resin, a light shielding resin, and an optical cover are engaged with each other. Therefore, the present embodiment is useful.

Further, FIG. 5 illustrates a case where each of the light transmitting resin layer 8 and the optical cover 12 has the depression(s) while the light shielding resin layer 6 has the projections. However, the present embodiment is not limited to this configuration.

For example, each of the light transmitting resin layer 8 and the optical cover 12 may be provided with a projection, while the light shielding resin layer 6 may be provided with depressions. Alternatively, each of all the light transmitting resin layer 8, the light shielding resin layer 6 and the optical cover 12 may be provided with both a depression and a projection.

In other words, (i) which of (a) a projection, (b) a depression or (c) both a projection and a depression is/are formed on each component member, and (ii) the number of the depression and/or the projection are not specifically limited, as long as the following configurations ((I), and (II) and/or (III)) can be achieved: (I) no disturbance occurs in a path of light emitted from the light emitting element and in a path of light reflected by an object; and (II) the light transmitting resin layer and the light shielding resin layer are engaged with each other by using a depression and a projection, and/or (III) the light shielding resin layer and the cover section are engaged with each other by a depression and a projection.

Further, in a case where any one or more of the light transmitting resin layer, the light shielding resin layer, and the cover section h as a plurality of depressions, all of the depressions are preferably used for engagement with respective corresponding projections. However, in such a case, in the present embodiment, only at least one depression needs to be used for such engagement.

For example, in FIG. 4, the optical cover 12 has the two depressions 18a and 18b. The depression 18a is engaged with the projection 13a of the light shielding resin layer 6a and the depression 18b is engaged with the projection 13c of the light shielding resin layer 6c.

Here, suppose that the light shielding resin layer 6c does not have the projection 13c (this supposed case is not shown). Then, there is no counterpart for the depression 18b in engagement. However, the depression 18a is engaged with the projection 13a. Therefore, even such a configuration makes it possible to more easily assemble an optical pointing device, as compared to a case where the optical cover 12 and the light shielding resin layer 6 are not engaged by using any depression/projection. Further, even such a configuration can also prevent displacement caused by vibration or the like.

A conventionally known molding method described above can be employed as a method for forming the depression and/or the projection on the light transmitting resin layer or the like. In other words, for example, it is possible to employ transfer molding or the like with the use of a metal mold in which a depression and/or projection of a desired shape is provided in advance in a desired position of the metal mold.

### Embodiment 3

### Linear Expansion Coefficients of Resins Respectively Constituting Light Transmitting Resin Layer, Light Shielding Resin Layer, and Cover Section

In general, metal, plastic, or the like cannot avoid expansion/contraction caused by a quick-heating thermal history. Accordingly, in an optical pointing device of Embodiment 3, a light transmitting resin layer, a light shielding resin layer, and a cover section are formed by using respective resins that have substantially equal liner expansion coefficients.

As described above, each of the light transmitting resin layer, the light shielding resin layer, and the cover section is a main component member of the optical pointing device, and is required to have heat resistance to a production process, such as reflow soldering, that adds a quick-heating thermal history. Accordingly, each of the light transmitting resin layer and the cover section is made of a resin containing thermosetting resin as a main component, while the light shielding resin layer is made of a resin containing, as a main component, thermosetting resin and/or thermoplastic resin that has heat resistance.

Further, in the present embodiment, respective resins of the above main component members are arranged to have substantially equal linear expansion coefficients. This makes it possible to prevent unevenness in degree of expansion/contraction caused by heat between the component members. As a result, it becomes possible to provide an optical pointing device whose heat resistance to a quick-heating thermal history, for example, in reflow soldering or the like, is improved.

The phrase “to have substantially equal linear expansion coefficients” means that in a case where a linear expansion coefficient of a resin constituting one of the light transmitting resin layer, the light shielding resin layer, and the cover section is defined as a reference value, each of respective linear expansion coefficients of resins constituting the other two of the light transmitting resin, the light shielding resin, and the cover section differs from the reference value, within a range of not more than 10% of the reference value. It is considered that this range does not cause a problem in suppressing unevenness in degree of expansion/contraction caused by heat between the component members.

It is more preferable if the difference is closer to 0%. In other words, most preferably, resins constituting the light transmitting resin, the light shielding resin, and the cover section have an equal linear expansion coefficient. Note that the linear expansion coefficients only need to be substantially equal, and absolute values of the respective linear expansion coefficients are not specifically limited.

### Embodiment 4

### Positioning of Component Members by Using Projection Originating from Gate

In an optical pointing device of Embodiment 4, at least one component member selected from a group consisting of a light transmitting resin layer, a light shielding resin layer, and a cover section has at least one projection. The at least one projection is used for positioning of each component member. This at least one projection is originating from a gate that was used in molding of the component member.

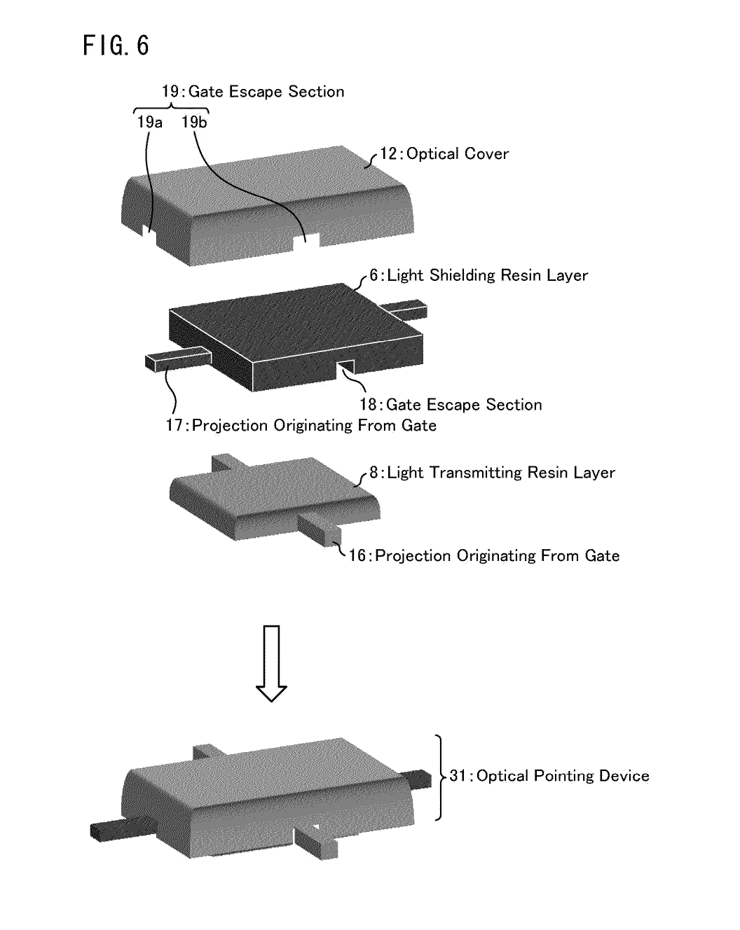

FIG. 6 is a schematic diagram illustrating a state where an optical pointing device 31 of Embodiment 4 is being assembled by using projections each of which is originating from a gate and each of which projections is formed on the light transmitting resin layer (light transmitting resin) 8 or the light shielding resin layer (light shielding resin) 6.

On the light transmitting resin layer 8, a projection 16 originating from a gate is formed. Meanwhile, on the light shielding resin layer 6, a projection 17 originating from a gate and a gate escape section (depression) 18 are formed. On an optical cover (cover section) 12, gate escape sections (depressions) 19 (19a and 19b) are formed.

In FIG. 6, the projection 16 originating from the gate is formed on the light transmitting resin layer 8, and this projection 16 is engaged with (i) the gate escape section 18 that is formed on the light shielding resin layer 6 and (ii) the gate escape section 19b that is formed on the optical cover 12. Meanwhile, the projection 17 originating from the gate is formed on the light shielding resin layer 6, and this projection 17 is engaged with the gate escape section 19a formed that is on the optical cover 12. In this way, the optical pointing device 31 of Embodiment 4 is assembled.

The term “gate” above is a member used in a conventionally known molding method such as transfer molding or the like. This “gate” is a member that forms an injection opening for filling melted resin into a metal mold. The melted resin is injected through the gate into the metal mold that is for molding a shape of each component member. The gate is not specifically limited, and may be a restricted gate or an unrestricted gate.

The melted resin filled in the metal mold is taken out of the metal mold after molding is completed. Then, the gate is generally an unnecessary portion on a product. Accordingly, in general, the gate is cut and discarded.

In Embodiment 4, the gate that is generally discarded is intentionally left on a molded product, and this gate is used as a projection for engagement between component members. In other words, the projections 16 and 17 are originating from respective gates.

The projections 16 and 17 originating from the respective gates can be obtained by cutting of the respective gates from runners, after the light transmitting resin layer 8 and the light shielding resin layer 6 are molded by a conventionally known molding method.

Meanwhile, each of the gate escape sections 18, 19a, and 19b only needs to have a shape that can be engaged with a corresponding projection 16 or 17. Each of the gate escape sections 18, 19a, and 19b can be obtained by (i) forming, in advance, a desired shape in a metal mold that is used for molding each of the light shielding resin layer 6 and the optical cover 12, and (ii) providing this metal mold for a conventionally known molding method.

In FIG. 6, the projection originating from the gate is formed on each of the light shielding resin layer 6 and the light transmitting resin layer 8. However, the Embodiment 4 is not limited to such a configuration. Further, the projection originating from the gate only needs to be arranged so that at least one projection originating from a gate is provided on at least one component member out of the light transmitting resin layer, the light shielding resin layer, and the cover section.

Regarding the optical pointing device 31 of Embodiment 4, component members can be more easily assembled and the gate generally discarded can be effectively utilized. Moreover, because strength against external pressure such as vibration or the like can be enhanced, it is possible to provide an optical pointing device whose optical characteristics and reliability are improved.

### Embodiment 5

### Optical Pointing Device that Employs Visible Light Cutting Resin

In an optical pointing device of Embodiment 5, a light transmitting resin layer and/or a cover section contains resin (visible light cutting resin) that has a visible light blocking characteristic.

The visible light cutting resin is a resin that does not transmit visible light but transmits light (infrared light) in an infrared region. The visible light cutting resin preferably does not transmit light that has a wavelength in a range of not more than 800 nm. However, in practice use, the visible light cutting resin only needs to have a characteristic that blocks light having a wavelength in a range of not more than 750 nm. The most preferable resin is a resin that does not transmit light that has a wavelength in a range out of a wavelength range of infrared light that is emitted from a light emitting element.

The visible light cutting resin is not specifically limited, but may be a conventionally known resin. Such visible light cutting resin can be, for example, discretionally selected resin, such as epoxy resin, acrylic resin, polycarbonate resin, or the like, to which a dye is mixed.

The optical pointing device is used as an input interface of a portable information device such as a mobile phone, a PDA, or the like. The portable information device is not only used indoors but also often used outdoors.

Further, the light emitting element used in the optical pointing device is realized by a light source such as an LED or the like as described above, and infrared light is employed. Accordingly, it is important to exclude rays of light except infrared light from the optical pointing device as much as possible.

In the optical pointing device of Embodiment 4, the light transmitting resin layer and/or the cover section contains visible light cutting resin. Therefore, it is possible to provide an effect such that disturbance light such as sunlight or the like is prevented from entering the optical pointing device.

Even in a case where only one of the light transmitting resin layer and the cover section contains visible light cutting resin, it is possible to obtain an effect such that disturbance light is prevented from entering the optical pointing device, as compared to a case where no visible light cutting resin is contained. Therefore, the present invention encompasses such a case in which visible light cutting resin is contained in only one of the above component members.

It is more preferable that both of the light transmitting resin layer and the cover section contains visible light cutting resin. This is because the effect obtained as described above can be improved more. It is the most preferable that both the light transmitting resin layer and the cover section are made of visible light cutting resin. This is because the effect obtained as described above can be most improved.

### Embodiment 6

### Optical Pointing Device Having Image Pick-Up Surface Formed in Depression of Cover Section

In an optical pointing device of Embodiment 6, a cover section has a depression. In the depression, an image pick-up surface is formed. Further, a distance from (i) a surface of the cover section on which surface the depression is formed to (ii) a bottom surface of the depression is arranged to be not more than a depth of field.

Due to characteristics of the optical pointing device, the optical pointing device can have, as a target object, not only a finger print but also anything, such as a copying paper or gloves, whose surface is uneven, and further can detect movement of such a target object.

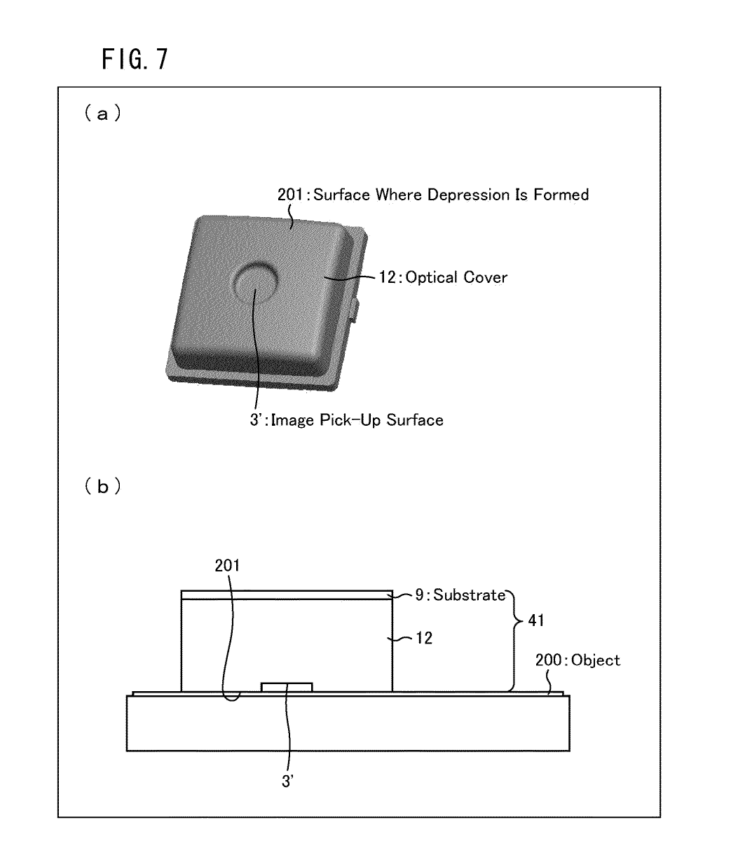

FIG. 7 illustrates Embodiment 6 of the present invention. (a) of FIG. 7 illustrate an appearance of an optical cover (cover section) 12 where an image pick-up surface 3′ is formed on a bottom surface of a depression; and (b) of FIG. 7 is a schematic view of an optical pointing device 41 employing the optical cover 12 as shown in (a) of FIG. 7 in a case where the optical pointing device is viewed from a side surface thereof.

In the optical cover 12 as shown in (a) of FIG. 7, a distance from a surface 201 where the depression is formed to a bottom surface of the depression is not more than a depth of field. Accordingly, when the optical pointing device 41 is provided on an object 200 as shown in (b) of FIG. 7, a section of the object 200 right below the image pick-up surface 3′ can be focused.

Therefore, by positioning the optical pointing device 41 on the object 200, as shown in (b) of FIG. 7, and moving the optical pointing device 41 on the object 200, the optical pointing device 41 can be used as an optical mouse. In this case, the image pick-up surface 3′ is present on the bottom surface of the depression that is formed on the surface 201. Therefore, even when the optical pointing device 41 is moved on the object 200, the image pick-up surface 3′ is not damaged.

The object 200 is not specifically limited as long as a surface of the object 200 is uneven. Examples of such an object 200 are a desk, a mouse pad, and the like, other than the copying paper and gloves as described above.

As described above, the optical pointing device of the present invention is a device that has excellent optical characteristics and reliability. The optical pointing device 41 of Embodiment 6 has the image pick-up surface 3′ thereof formed on the bottom surface of the depression that is formed on the optical cover 12.

Therefore, the optical pointing device of Embodiment 6 can provide an optical mouse whose image pick-up surface is hard to be damaged and whose optical characteristics and reliability are excellent. In addition, such an optical mouse is user-friendly.
Note that in the present specification, the phrase “a surface of the cover section on which surface the depression is formed” indicates a top surface of the optical cover 12. For example, the surface is a surface indicated by the reference sign 201 in (a) of FIG. 7.

### Embodiment 7

### Electronics Device Including Optical Pointing Device

An electronics device of the present invention includes an optical pointing device of the present invention. The electronics device is not specifically limited. Examples of the electronics device are a mobile phone, a PDA, a PC (particularly, mobile PC), a game machine, a digital camera, a remote controller and the like.

The optical pointing device of the present invention has excellent optical characteristics and reliability against external pressure. Further, in the optical pointing device, disturbance light is prevented from entering the optical pointing device. Therefore, preferably, the optical pointing device is often used particularly in an electronics device that is frequently used outdoors. By using the optical pointing device as an input device in the electronics device, operational reliability and stability of the electronics device can be improved.

Further, as compared to a conventionally known optical pointing device, the number of component members are reduced in the optical pointing device of the present invention. Therefore, the optical pointing device of the present invention can contribute to reduction in thickness and size of the electronics device.

The present invention can also be configured as follows.

In the optical pointing device of the present invention, preferably, the light transmitting resin has a depression between the light emitting element and the image pick-up element; and a distance from the substrate to a bottom surface of the depression is not more than a height of the light emitting element.

According to the above configuration, the depression comes between the light emitting element and the image pick-up element, and a distance from the substrate to the bottom surface of the depression is adjusted as described above. This makes it possible to prevent light from directly entering the image pick-up element from the light emitting element.

Therefore, it becomes possible to provide an optical pointing device having a high performance that does not suffer influence of stray light.

In the optical pointing device of the present invention, preferably, each of the light transmitting resin layer and the light shielding resin layer has a depression and/or a projection, and (i) at least one of the depression of the light transmitting resin layer is engaged with a corresponding projection of the light shielding resin layer or (ii) at least one of the depression of the light shielding resin layer is engaged with a corresponding projection of the light transmitting resin layer; and/or each of the light shielding resin layer and the cover section has a depression and/or a projection, and (i) at least one of the depression of the light shielding resin layer is engaged with a corresponding projection of the cover section or (ii) at least one of the depression of the cover section is engaged with a corresponding projection of the light shielding resin layer.

According to the above configuration, it becomes possible to easily and reliably carry out positioning of the light transmitting resin layer, the light shielding resin layer and the cover section that are important component members constituting the optical pointing device of the present invention. Further, at least two of the above component members are engaged with each other.

Therefore, misalignment of the component members can be prevented and uneven light passage can be prevented. This makes it possible to make optical characteristics be stable and thereby to provide a high operational stability.

Therefore, it becomes possible to provide an optical pointing device that has superior optical characteristics and reliability, that can be subjected to reflow soldering, and that can be easily assembled.

In the optical pointing device of the present invention, preferably, the light transmitting resin layer has a depression between the light emitting element and the image pick-up element; a distance from the substrate to a bottom surface of the depression is not more than a height of the light emitting element; and the depression is engaged with a corresponding projection of the light shielding resin layer.

According to the above configuration, the depression comes between the light emitting element and the image pick-up element, and a distance from the substrate to the bottom surface of the depression is adjusted as described above. Further, the projection of the light shielding resin layer is engaged with the depression. This makes it possible to more reliably prevent light from directly entering the image pick-up element from the light emitting element.

Therefore, it becomes possible to provide an optical pointing device having a high performance that allows further excluding influence of stray light.

In the optical pointing device of the present invention, preferably, the light transmitting resin layer, the light shielding resin layer, and the cover section are made of resins having substantially equal linear expansion coefficients, respectively.

According to the above configuration, respective linear expansion coefficients of main component members of the optical pointing device are arranged to be substantially equal. This makes it possible to prevent unevenness in degree of expansion/contraction caused by heat that is applied to each of the component members. Consequently, distortion, displacement, and the like between the component members can be reduced.

Therefore, it becomes possible to provide an optical pointing device that has a better heat resistance and that is more stable against a process, such as reflow soldering or the like, that adds a quick-heating thermal history.

In the optical pointing device of the present invention, preferably, at least one member selected from a group consisting of the light transmitting resin layer, the light shielding resin layer and the cover section has at least one projection; and the at least one projection is originating from a gate used for molding the at least one member.

According to the above configuration, a gate used in molding a component member above can be directly used as a projection for positioning of component members. Accordingly, it is not necessary to separately form the projection. This makes it possible to simplify a structure of a metal mold used in molding.

Consequently, it becomes possible to obtain an optical pointing device that can sufficiently prevent misalignment of component members in a simpler process. Further, it becomes possible to reduce a size of the optical pointing device.

In the optical pointing device of the present invention, preferably, one or both of the light transmitting resin layer and the cover section contains a resin having a characteristic that does not allow visible light to pass through the resin.

Because the optical pointing device of the present invention includes the light shielding resin layer, disturbance light or the like can be prevented from entering the image pick-up element. According to the above configuration, disturbance light or the like can be more effectively prevented by a resin (hereinafter, also referred to as visible light cutting resin) having a characteristic that does not allow visible light to pass through the resin.

Therefore, it is possible to provide an optical pointing device that is more suitable for use in a portable information terminal that is often used outdoors.

In the optical pointing device of the present invention, preferably, the cover section is provided with a depression in which an image pick-up surface is formed; and a distance from (i) a surface of the cover section on which surface the depression is formed to (ii) a bottom surface of the depression is not more than a depth of field.

According to the above configuration, even in a case where the optical pointing device of the present invention is moved on an object having a projection/depression, the image pick-up surface is not damaged. Therefore, the optical pointing device can be used as, for example, an optical mouse.

In addition, as described above, the optical pointing device of the present invention has excellent optical characteristics and reliability. Therefore, an image pick-up surface is hard to be damaged. Accordingly, it is possible to provide an optical mouse that has excellent optical characteristics and reliability and that is user-friendly.

The electronics device of the present invention includes an optical pointing device of the present invention.

The optical pointing device of the present invention has excellent optical characteristics, reliability, and heat resistance. Accordingly, with the above configuration, it is possible to provide an electronics device that includes the optical pointing device as one of component members mounted at a high density and that has excellent optical characteristics and reliability.

In addition, the optical pointing device has a reduced number of component members as compared to that of a conventionally known optical pointing device. Accordingly, the above configuration makes it possible to provide an electronics device whose size is reduced.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The optical pointing device of the present invention can be suitably used as an input device for, for example a PC, a mobile phone, a remote controller, a digital camera, a PDA, and the like.

### REFERENCE SIGNS LIST

1, 21, 31, 41 optical pointing device
2 light emitting element
3, 3′ image pick-up surface
4, 4′ optical unit
5, 5′ lens unit
6 light shielding resin layer (light shielding resin)
7 image pick-up element
8 light transmitting resin layer (light transmitting resin)
9 substrate
10, 11 light transmitting section
12, 12′ optical cover (cover section)
13 projection of light shielding resin layer (light shielding resin)
14 lens section
15 depression of light transmitting resin layer (light transmitting resin)
16 projection of light transmitting resin layer (light transmitting resin) originating from gate
17 projection of light shielding resin layer (light shielding resin) originating from gate
18, 19 gate escape section (depression)
201 surface where depression is formed on optical cover (cover section)

1. An optical pointing device comprising:
a light emitting element provided on a substrate and emitting light onto an object;
an image pick-up element provided on the substrate and receiving light reflected by the object;
a light transmitting resin layer sealing the light emitting element and the image pick-up element;
a light shielding resin layer sealing the light transmitting resin layer, except a section having a possibility of becoming a path of the incident light and a path of the light reflected by the object; and
a cover section sealing the light shielding resin layer,
the cover section being integrally molded with an optical unit and a lens unit,
the optical unit refracting incident light from the light emitting element toward the object, the lens unit collecting the light reflected by the object,
the light transmitting resin layer and the cover section each being made of a resin containing thermosetting resin as a main component,
the light shielding resin layer being made of a resin containing, as a main component, thermosetting resin and/or thermoplastic resin that has heat resistance.

2. The optical pointing device as set forth in claim 1, wherein:
the light transmitting resin layer has a depression between the light emitting element and the image pick-up element; and
a distance from the substrate to a bottom surface of the depression is not more than a height of the light emitting element.

3. The optical pointing device as set forth in claim 1, wherein:
each of the light transmitting resin layer and the light shielding resin layer has a depression and/or a projection, and
(i) at least one of the depression of the light transmitting resin layer is engaged with a corresponding projection of the light shielding resin layer or (ii) at least one of the depression of the light shielding resin layer is engaged with a corresponding projection of the light transmitting resin layer; and/or
each of the light shielding resin layer and the cover section has a depression and/or a projection, and
(i) at least one of the depression of the light shielding resin layer is engaged with a corresponding projection of the cover section or (ii) at least one of the depression of the cover section is engaged with a corresponding projection of the light shielding resin layer.

4. The optical pointing device as set forth in claim 2, wherein:
the depression is engaged with a corresponding projection of the light shielding resin layer.

5. The optical pointing device as set forth in claim 1, wherein:
the light transmitting resin layer, the light shielding resin layer, and the cover section are made of resins having substantially equal linear expansion coefficients, respectively.

6. The optical pointing device as set forth in claim 1, wherein:
at least one member selected from a group consisting of the light transmitting resin layer, the light shielding resin layer and the cover section has at least one projection; and
the at least one projection is originating from a gate used for molding the at least one member.

7. The optical pointing device as set forth in claim 1, wherein:
one or both of the light transmitting resin layer and the cover section contains a resin having a characteristic that does not allow visible light to pass through the resin.

8. The optical pointing device as set forth in claim 1, wherein:
the cover section is provided with a depression in which an image pick-up surface is formed; and
a distance from (i) a surface of the cover section on which surface the depression is formed to (ii) a bottom surface of the depression is not more than a depth of field.

9. An electronics device comprising an optical pointing device as set forth in claim 1.
